(19) United States
(12) Patent Application Publication
(10) Pub. No.: US 2004/0212221 A1
(43) Pub. Date: Oct. 28, 2004

(54) Cab roof member for work machine

(75) Inventor: Kanichi Sato, Osaka (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/816,488

(22) Filed: Mar. 31, 2004

(30) Foreign Application Priority Data
Apr. 25, 2003 (JP) 2003-121548

(51) Int. Cl. B62D 33/06

(52) U.S. Cl. 296/190.08

(57) ABSTRACT

A cab roof member for a work machine is provided, which is provided with improved measures for protecting the operator and insulating noise and has improved economical efficiency and a good design. To this end, the cab roof member comprises a foam made by foaming a plastic material in which a net-like or fabric-like reinforcing material consisting of a high-strength organic fiber or an iron plate is included, so that the operator can be protected from falling objects and the work environment of the operator's cab can be improved in terms of noise insulation and heat insulation.

### TECHNICAL FIELD

The present invention relates to a cab roof member well suited for use in a work machine such as construction equipment (e.g., hydraulic excavators), hoisting machinery (e.g., fork lifts) and farm machinery (e.g., tractors).

### BACKGROUND ART

Examples of work machines and, more particularly, work vehicles include construction equipment (e.g., hydraulic excavators), farm machinery (e.g., tractors) and hoisting machinery. These machines have an operator's cab which is mounted in an upper position of the vehicle body and where the operator sits for operating the machine. Usually, the operator's cab of a construction machine used for earth movement and excavating operation, for example, has a hermetically closed structure in order to protect the operator from falling objects, rain, wind, dust and ambient noise. The roof of the operator's cab functions to provide good appearance and protect the operator from falling objects. In the case of construction machines, civil engineering work and fundamental construction work which involve earth excavation and demolition work are often carried out on the unleveled ground. Operations at a footless work site such as the sloping ground are done the vehicle body being tilted. Under such circumstances, there is a risk of rollovers of the vehicle body.

For this reason, there is such a movement that work machine manufactures are obliged to structure operator's cabs so as to involve less frame distortion in order that the operator in the operator's cab can be protected even if the vehicle body rolls over, imposing a tipping load on the operator's cab. The frames of the operator's cab accordingly need to be firmly built. As the number of reinforcing members employed particularly in the roof increases, the conventional sheet metal structures cannot meet the demands in terms of functions and the design of exterior package.

As an attempt to solve this problem, there have been proposed cab roofs composed of a plastic structural member such as disclosed in Japanese Kokai Patent Publication No. 9-2326. This roof structure assembly composed of a plastic structural member is formed by molding so as to enclose and hermetically seal the upper part of the operator's cab and provided with a flange for joining the roof to the frame which constitutes the skeletal structure of the operator's cab. A plurality of metal bars are embedded in the flange and a foamed material is molded integrally with the flange to seal the joint area. According to this publication, there is provided a socket for a lightening fixture which socket is integral with the front end of the roof structure assembly composed of a plastic structural member and the need for painting is obviated by making the roof from a plastic material, so that improved appearance can be obtained.

Another operator's cab has been proposed by Japanese Kokai Patent Publication No. 10-8500 according to which whereas the framework of the operator's cab is constituted by steel frames, the side and ceiling panels enclosing the framework are formed from plastic molded articles. In this prior art operator's cab, a ceiling panel is provided in which a plurality of steel bars aligned at specified intervals and a woven metal wire are used in combination as reinforcing materials and which is integrated by use of an olefin-based resin. Another operator's cab has been proposed by Japanese Kokai Patent Publication No. 2000-273910 in which the canopy body is made from plastic and storage parts are integrally formed with the ceiling.

The roof structure assembly disclosed in Japanese Kokai Patent Publication No. 9-2326 is entirely formed by plastic molding. However, where the roof portion is formed from plastic material only, the roof is likely to be broken down if a heavy load object falls on it, in spite of improvements in the means for attaching the roof to the metal frame, the grip rail structure and the attachment structure for the lightening fixture. Therefore, it is difficult to say this roof assembly can provide satisfactory protection for the operator. Also, this roof assembly is complicated in structure which leads to increased production cost.

The prior art disclosed in Japanese Kokai Patent Publication No. 10-8500 can provide improved strength against falling objects because metallic reinforcing members are molded integrally with the surface that constitutes the roof portion, but the operator's cab panels of this type suffer from the problems of poor weather resistance and unsatisfactory noise insulation. When these panels are used for constructing the outer circumference part of a hermetically closed operator's cab, the operator's cab is utterly vulnerable to noise penetrating from outside particularly in the area near noise sources such as the engine and the hydraulic motor. While there have been demands for heat insulation for the purpose of air-conditioning and strength to withstand impacts from outside, this prior art has not reached a point where those demands are met except the reinforcement measure. More concretely, the desired strength may be accomplished but the work environment cannot be satisfactorily improved only by integral molding of reinforcing materials.

Japanese Kokai Patent Publication No. 2000-273910 merely teaches provision of pockets for storing small things, papers or the like which pockets are formed when forming the roof structural member from plastic but does not suggest any measures for improving the work environment.

The present invention has been made taking the above-described situation into account, and therefore a primary object of the invention is to provide a cab roof member for a work machine, which is provided with improved measures for protecting the operator from ambient elements and insulating noise and, at the same time, has good economical efficiency and good design.

### DISCLOSURE OF THE INVENTION

The above object can be accomplished by a cab roof member for a work machine according to a first aspect of the invention,

which is a roof member of an operator's cab of a work machine and which comprises a foam formed by foaming a plastic material in which a net-like or fabric-like reinforcing material consisting of a high-strength organic fiber is included.

In the invention, a plastic material having high mechanical strength is foamed to form a panel in which a net or cloth of a high-strength fiber is included as a reinforcing material, whereby the strength of the resultant cab roof member against external force can be increased, heat insulation/damping effects can be obtained by foaming, weight reduction can be promoted, and a good design can be achieved because the plastic material is molded into a desired outer shape. In addition, it is possible to integrally mold desired members and parts so that the number of parts can be reduced, leading to improved efficiency in assembling the cab roof member.

According to a second aspect of the invention, there is provided a cab roof member for a work machine,

which is a roof member of an operator's cab of a work machine and which comprises a foam formed by foaming a plastic material in which a reinforcing material consisting of an iron plate is included.

In the invention, a plastic material having high mechanical strength is foamed to form a panel in which an iron plate is included as a reinforcing material, whereby a strong panel can be produced, the embedded iron plate has the function of insulating noise because of its mass effect, and the heat insulation/damping effects of the foamed layer can be obtained, leading to an improvement in the environment of the operator's cab.

According to a third aspect of the invention, there is provided a cab roof member for a work machine,

which is a roof member of an operator's cab of a work machine and wherein a sound absorption functional layer is formed on a face of a foam formed by foaming a plastic material, the face of the foam being located on the side corresponding to a ceiling face of the operator's cab.

In the invention, a sound absorption functional layer is formed at the ceiling face side and this sound absorption functional layer is composed of a bulky material thereby obtaining an improved sound absorption effect and imparting a soft feeling to the appearance of the ceiling face. In addition to an increased degree of freedom in forming the outer shape of the roof which has been obtained by use of a foamed resinous material, the functionality of the entire cab roof member can be increased and the design effect of its appearance can be improved.

In each aspect of the invention, it is preferable that the plastic material to be foamed is a polyurethane resin. Use of a polyurethane resin makes it possible to employ the reactive injection molding (that is one of the low pressure molding techniques and abbreviated to “RIM method”) so that the sound absorption material can be easily integrated with the foam made from the soft material. Also, an impact-resistant member can be easily incorporated and the outer shape of the cab roof member can be freely designed, so that the strength of the roof for withstanding a tipping load and falling objects (which are the outstanding problems) can be ensured, whereas a noise insulation/sound absorption effect, heat insulation effect and good design can be achieved. In addition, since the low pressure molding method can be employed for manufacturing the cab roof member, it becomes possible to use a resinous die in molding and therefore reduce the cost of the die, and as a result, considerable cost reduction can be achieved compared to the prior art.

Preferably, the high-strength organic fiber is selected from the group consisting of polyamide single fibers, polyester-based high-strength fibers, carbon fibers and any combination thereof. By use of such a reinforcing material, the fiber component of the material exerts good bondability with respect to the molded resin so that the molded part does not become bulky and improved penetration resistance can be ensured for reinforcement.

Preferably, the iron plate has enough strength to withstand shocks caused by falling objects and is larger in size than a structural member for keeping the strength of the operator's cab. Accordingly, the iron plate is not thin but may be thickened within an allowable range (e.g., 3.2 mm to 4.5 mm with which the strength of the iron plate can be ensured). By selecting a size convenient for mechanically joining the iron plate to the frame of the operator's cab structure, the assembly of the structure can be facilitated. Additionally, fastening pieces used for fastening the cab roof member to the operator's cab structural frame may be joined to the incorporated iron plate beforehand by welding or the like. This leads to improved workability in molding.

Preferably, the top face of the cab roof member is curved so as to bulge upwardly and the reinforcing material is included in the cab roof member so as to extend along the curved face. With this arrangement, a compressive stress can be generated in the cab roof member at the instant when a falling object hits on it, so that increased impact resistance can be attained. This arrangement also gives an aesthetic effect to the appearance of the operator's cab.

Preferably, the sound absorption functional layer is constituted by a polyurethane foam, a foam of a polyolefin-based material, a PET fiber, a glass fiber, or any combination thereof. It is preferable to cover the surface of the sound absorption functional layer with a sheet material having high porosity selected from cotton fabrics, nylon fabrics and nonwoven fabrics. By covering the sound absorption functional layer with a sheet material having high porosity, a decorative effect can be given to the outer face and, more particularly, inner face of the operator's cab to improve the work environment and the sound absorbability of the functional layer can be improved.

Preferably, the surface of the sound absorption functional layer is covered with a thin thermoplastic sheet material. With this arrangement, the surface of the sound absorption functional layer can be embossed, which offers an additional decorative effect and a desired tactile impression, so that the design can be further improved.

Preferably, the cab roof member of the invention is molded with fastening pieces embedded in its joint area which is to be joined to the structural frame of the operator's cab, and mating fastening members are brought into engagement with the fastening pieces through the structural frame when assembling the operator's cab, whereby the cab roof member can be integrated with the structural frame. Since the fastening pieces used for assembly of the operator's cab are formed beforehand by insertion molding, assembly can be carried out simply by engaging the mating fastening members, which leads to an improvement in work efficiency. In addition, the fastening pieces and the mating fastening members can be concealed, which also provides a desirable design effect.

Preferably, the included reinforcing material and the sound absorber provided at the ceiling face side are integrated with the foam. It is also preferred that the cab roof member is formed by reactive injection molding of a polyurethane resin. With this arrangement, the reinforced, highly-durable thick cab roof member can be easily manufactured so as to have a desired outer shape and a structure having functions suited for the work environment where the work machine is used. In addition, the low pressure molding method allows use of a resinous die, which significantly saves the cost of the die, resulting in cost reduction.

In the invention, it is preferred that a mold coating layer or painted sheet laminated layer is formed on the top face side of the cab roof member. With this arrangement, the mold coating layer or painted sheet laminated layer is integrated with the top face of the cab roof member that is formed by the low pressure molding method, so that the pretreatment (e.g., removal of a mold release agent and sanding) which is usually required when painting ordinary molded products becomes unnecessary. As a result, further cost reduction can be expected and the original appearance of the surface can be kept without spoiling the exterior decoration.

### BRIEF DESCRIPTION OF THE DRAWINGS

FIG. 1 is a general perspective view of an operator's cab of a work vehicle to which a cab roof member constructed according to a first embodiment of the invention is applied.

FIG. 2 is a sectional view that diagrammatically illustrates a longitudinal section of the cab roof member according to the first embodiment.

FIG. 3 is a sectional view that diagrammatically illustrates a longitudinal section of a cab roof member according to a second embodiment of the invention.

FIG. 4 is a partially enlarged sectional view illustrating the internal structure of a cab roof member according to a third embodiment of the invention.

FIG. 5 is a partially enlarged sectional view illustrating the internal structure of a cab roof member according to a fourth embodiment of the invention.

FIG. 6 is a partially enlarged sectional view illustrating the internal structure of a cab roof member according to a fifth embodiment of the invention.

FIG. 7 is a partially enlarged sectional view illustrating the internal structure of a cab roof member according to a sixth embodiment of the invention.

FIG. 8 is a partially enlarged sectional view illustrating the internal structure of a cab roof member according to a seventh embodiment of the invention.

FIG. 9 is a partially enlarged sectional view illustrating the internal structure of a cab roof member according to an eighth embodiment of the invention.

FIGS. 10(a) and 10(b) are sectional views illustrating examples of the ways of molding the cab roof member according to the embodiments.

### BEST MODE FOR CARRYING OUT THE INVENTION

Referring now to the accompanying drawings, a cab roof member for use in a work machine will be hereinafter described according to preferred embodiments of the invention.

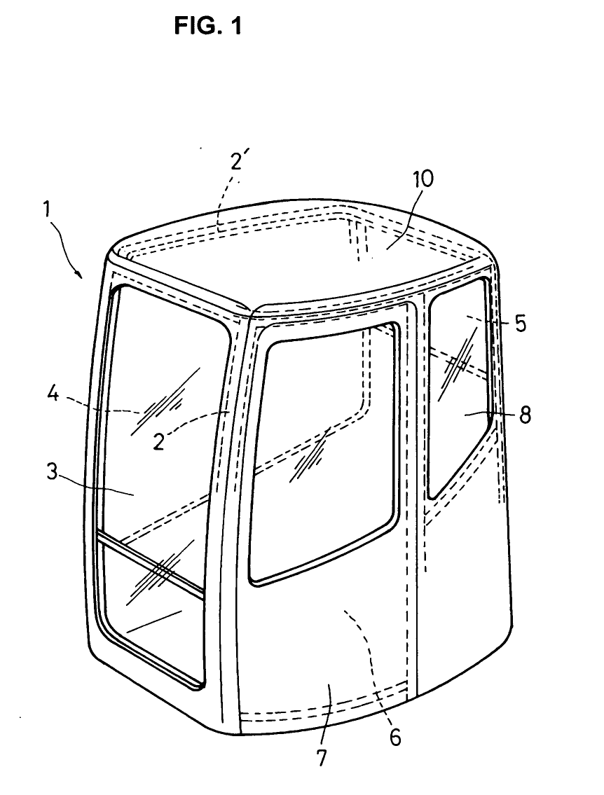

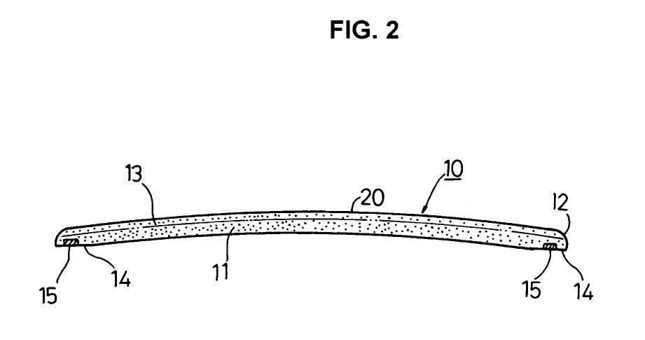

FIG. 1 is a general perspective view of an operator's cab of a work vehicle to which a cab roof member constructed according to a first embodiment of the invention is applied. FIG. 2 is a longitudinal sectional view of the cab roof member according to the first embodiment.

The operator's cab 1 having the cab roof member of the first embodiment includes an operator's cab structural frame 2 constituted by structural materials so as to have a desired outer dimension; a panel that encloses the operator's cab structural frame 2, forming at least four faces; and a cab roof member 10 resting on and integrally coupled by fastening members to an upper member 2′ that defines the top edge of the operator's cab structural frame 2. The panel constituting the outer circumferential side faces of the operator's cab 1 includes a front window 3 located at the front side, a side window 4 that is located at the right side so as to face the work implement, and a rear window 5 located at the upper half of the rear side. At the left side, there are provided a door way 6, a door 7 and a window 8 that is located at the upper part of the rear half portion of the left side. The operator sitting on an operator's seat (not shown) inside the cab 1 can operate the machine while visually checking the outside through the windows.

The cab roof member 10 for constituting the top face of the operator's cab 1 of the above structure is mounted such that the rim of the roof member 10 fits the contour of the top edge of the panel enclosing the operator's cab 1. The cab roof member 10 is composed of a panel that is formed from a foamed resin so as to have desired thickness and the structure described below.

The cab roof member 10 is formed as illustrated in FIG. 2 that diagrammatically shows a longitudinal section of the cab roof member 10. More concretely, a plastic material is foamed to make a foam (base material layer 11) having desired thickness, and this foam is made into a panel having a desired dimension as a cab roof member. A net or cloth made of a high-strength organic fiber is included as a reinforcing material 13 so as to extend throughout the panel. A rim 12 of the panel is flattened such that the panel is joined to the top edge of the operator's cab structural frame 2. At a plurality of positions in a joint area 14 of the panel, a nut (fastening piece) 15 is embedded.

As a plastic foam material for forming the base material layer 11 (foam) that is a main body of the cab roof member 10, a polyurethane resin is used. The cab roof member 10 is integrally formed through foaming in which the RIM (Reactive injection molding) method and a desired die (described later) are employed. The reinforcing material 13 included is a material in the form of a net or cloth made by weaving a polyamide single fiber (i.e., an untwisted fiber like fishing lines), polyester-based high-strength fiber, carbon fiber or any combination thereof.

The reinforcing material 13 is plastically deformed with its center upwardly bulging and is integrally included in the foam material, so that the cab roof member 10 has a curved top face 20 which upwardly bulges at its center. With this arrangement, displacement of the reinforcing material 13 in the direction of thickness during molding can be prevented so that the material 13 can be positioned in the mid position with respect to the direction of thickness. Further, if an impact caused by a falling object is imposed, a compressive stress will occur, thereby increasing the impact resistance of the cab roof member 10. The upwardly bulged shape also gives a good design effect to the appearance of the operator's cab.

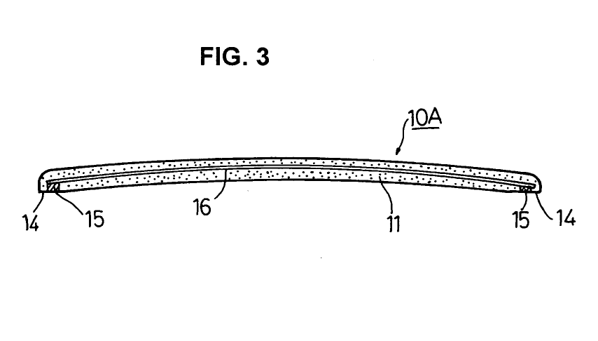

FIG. 3 shows a diagrammatic longitudinal sectional view of a cab roof member constructed according to a second embodiment of the invention. The fundamental structure of the cab roof member of the second embodiment is the same as that of the first embodiment except that the second embodiment uses an iron plate as the reinforcing material. Therefore, in the second embodiment, the parts that are identical with or similar to those of the first embodiment will be given the same reference numerals as of the first embodiment and a detailed description thereof will be skipped (the same is applied to third to eighth embodiments).

A cab roof member 10A of the second embodiment has a desired outer dimension and is integrally formed from a foamed resin so as to include an iron plate as a reinforcing material 16 the size of which falls within such a range that allows the cab roof member 10A to be joined to the operator's cab structural frame 2. The iron plate is 3.2 to 4.5 mm thick and has a curved face bulging upwardly. The thickness of the iron plate is determined according to the size of the operator's cab and others. Where such an iron plate is included into the base material layer 11 as the reinforcing material 16, not only can the cab roof member 10A be more strongly reinforced but also the noise insulation effect for shutting out noise from outside can be further improved thanks to the mass of the iron plate.

By integrally attaching the plurality of nuts 15 to the iron plate by welding or the like beforehand so as to be located in the joint area 14 which is to be joined to the operator's cab structural frame 2, the iron plate can be supported in a proper position by the nuts 15 when the panel is molded with the iron plate interposed therein, so that the positioning of the iron plate can be facilitated. Although it is desirable that the iron plate interposed in the foam (the base material layer 11) have no through holes, satisfactory bondability can be obtained by use of polyurethane as the foamed resin so that the iron plate does not come off during use.

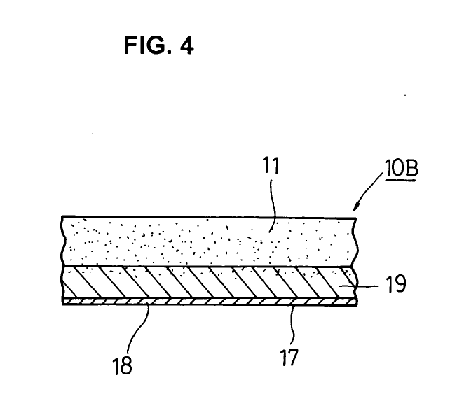

FIG. 4 shows a partially enlarged sectional view of the internal structure of a cab roof member constructed according to a third embodiment of the invention.

In the cab roof member 10B of the third embodiment, a mold coating layer 18 and a sound absorbing layer (sound absorption functional layer) 19 are formed, apart from the reinforcing material 13 (or 16) described in the first (or second) embodiment and the embedded nuts 15. The mold coating layer 18 is positioned on the ceiling face 17 side of the cab roof member 10B, whereas the sound absorbing layer 19 of proper thickness is formed on the side of the inner face of the mold coating layer 18, these layers 18, 19 being integral with the foam (the base material layer 11). As the material of the sound absorbing layer 19, a polyurethane foam (that is the same as the resinous material that substantially constitutes the cab roof member), a foam of a polyolefin-based material, a PET fiber (polyethylene terephthalate), a glass fiber, or any combination thereof may be used. The sound absorbing layer 19 is formed so as to have desired thickness and extend throughout the cab roof member and is integrated by the foamed resin. Since proper pores can be formed in the sound absorbing layer 19 during molding and moderate flexibility can be given to the sound absorbing layer 19 by employing the above materials, the sound absorbing layer 19 can maintain its shape retention effect while functioning as a sound absorber, so that it can be integrated with the molded foamed resin portion without becoming detached therefrom even if it receives external force. The thickness ratio of the sound absorbing layer 19 to the base material layer 11 (consisting of the foam) is arbitrarily determined depending on the sound absorbability, design and other factors of the machine type used (the same is applied to the following embodiments).

By crimping the surface of the die corresponding to the ceiling face 17 of the cab roof member 10B, the mold coating layer 18 can be crimped in the process of molding so that an article having the crimped ceiling face 17 can be produced and therefore an improved aesthetic effect can be expected. As the material of the mold coating layer 18, a thermoplastic elastomer (thermoplastic rubber) or the like is used, which facilitates the patterning and enables formation of a surface layer having a soft tactile impression.

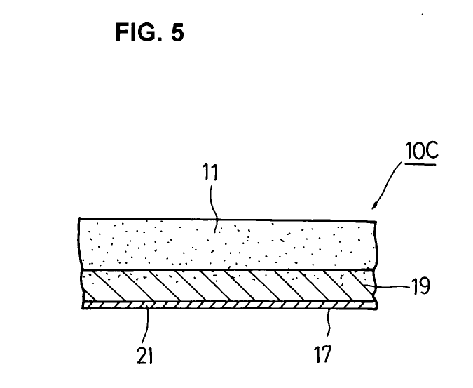

FIG. 5 shows a partially enlarged sectional view of the internal structure of a cab roof member constructed according to a fourth embodiment of the invention.

The cab roof member 10C of the fourth embodiment is formed as a single piece in which a sheet material 21 made from an olefin-based foam having a leather-like surface (e.g., “PEF” produced by Toray Industries, Inc.) is disposed instead of the mold coating layer 18 of the cab roof member 10B of the third embodiment and the sheet material 21 is laminated to the sound absorbing layer 19 to be integrated with the foam resin.

In the cab roof member 10C having such a structure, the ceiling face 17 has the tactile impression of soft leather and a beautiful outer face. Other examples of the leather-like sheet material 21 include olefin-based materials having a thickness of 0.1 to 0.6 mm and chloroethylene (PVC)-based materials.

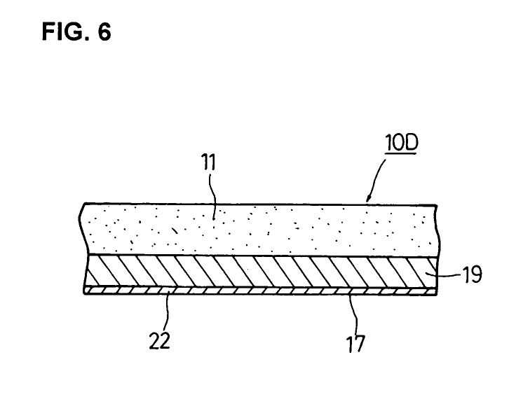

FIG. 6 shows a partially enlarged sectional view of the internal structure of a cab roof member constructed according to a fifth embodiment of the invention.

The cab roof member 10D of the fifth embodiment is formed as a single piece in which a nonwoven cloth sheet 22 is formed from e.g., a PET fiber in the position of the ceiling face 17 instead of the mold coating layer 18 or leather-like sheet 21 of the cab roof members described in the foregoing embodiments, and the nonwoven cloth sheet 22 is integrated with the foam (the base material layer 11) together with the sound absorbing layer 19. With this arrangement, the nonwoven cloth sheet 22 is positioned on the ceiling face 17 side and, thus, the cab roof member having a fiber surface can be easily obtained. It should be noted that a fabric material having air permeability such as a cotton fabric or nylon fabric can be used in place of the nonwoven cloth sheet 22.

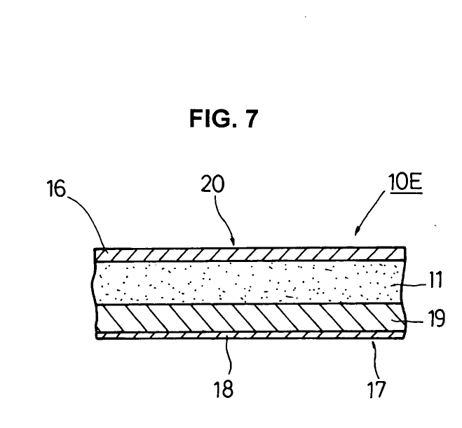

FIG. 7 shows a partially enlarged sectional view of the internal structure of a cab roof member constructed according to a sixth embodiment of the invention.

In the cab roof member 10E of the sixth embodiment, an iron plate (the reinforcing member 16) is located on a top face (outer surface) 20 side and the mold coating layer 18 is formed on the ceiling face 17 side integrally with the base material layer 11 and the absorbing layer 19. The mold coating layer 18 is the same as those described in the foregoing embodiments and therefore the same effect as of the foregoing embodiments can be obtained. The iron plate (the reinforcing member 16) disposed so as to constitute the top face 20 also functions as a sound insulating board and the surface (i.e., the top face 20) of the iron plate can be painted to decorate the appearance of the operator's cab.

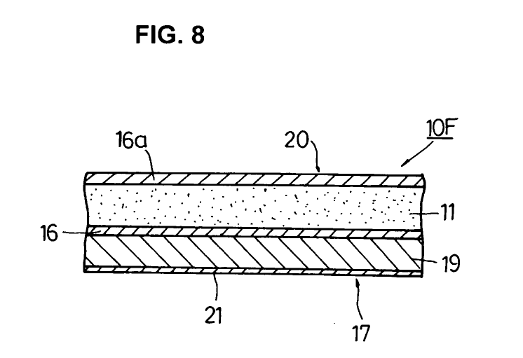

FIG. 8 shows a partially enlarged sectional view of the internal structure of a cab roof member constructed according to a seventh embodiment of the invention.

The cab roof member 10F of the seventh embodiment is formed as a single piece in which an iron plate 16a is formed on the top face (outer surface) 20 side, whereas the leather-like sheet 21 (e.g., “PEF” produced by Toray Industries, Inc.) is formed on the ceiling face 17 side, and another iron plate is included as the reinforcing member 16 between the foam serving as the base material layer 11 and the inner face of the sound absorbing layer 19. In the cab roof member 10F having the above structure, the top face 20 is constituted by the iron plate 16a, another iron plate is inserted as the reinforcing material 16 and, moreover, the sound absorbing layer 19 is provided. Therefore, the iron plate 16a is exposed at the ceiling face side, functioning as a reinforcing material as well as a sound insulator whereas the internally disposed reinforcing material 16 exerts strength maintaining and sound insulating effects, so that further improvements can be expected. In addition, the ceiling face 17 is constituted by the leather-like sheet material 21 so that a beautiful interior which gives a soft impression can be achieved. The sound absorbing layer 19 further gives a sound absorbing effect in addition to the sound insulation achieved by the iron plates 16, 16a and gives a cushioning effect to withstand external force working from the ceiling face 17 side.

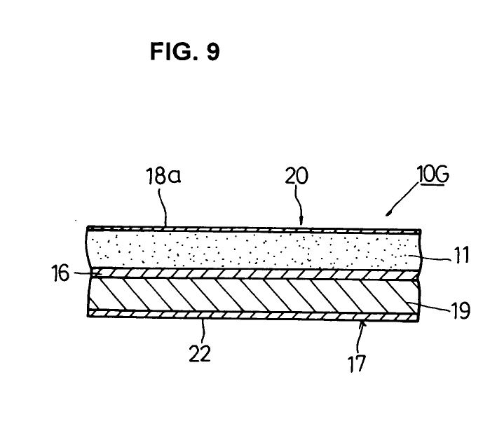

FIG. 9 shows a partially enlarged sectional view of the internal structure of a cab roof member constructed according to an eighth embodiment of the invention.

The cab roof member 10G of the eighth embodiment is formed as a single piece in which a mold coating layer 18a is provided on the top face 20 side whereas the nonwoven cloth sheet 22 is provided on the ceiling face 17 side, and in which there are provided the sound absorbing layer 19 and the reinforcing material 16 consisting of an iron plate which is interposed in the middle of the cab roof member, these members being integrated with the base material layer 11 made from a foamed resin material. In the cab roof member 10G having the above structure, the outer surface of the base material layer 11 is covered with the mold coating layer 18a located in the top face 20. Therefore, a firm painted face can be attained by using, in molding, a mold coating material having a color tone that fits the paint of the operator's cab. This eliminates not only the need for a finish painting step but also a possibility of exfoliation, so that the maintenance of the exterior becomes unnecessary over a long period of time. Apart from the above points, the same functions and effects as described earlier can be obtained. The same effects can be achieved by providing a painted sheet laminated layer instead of the mold coating layer 18a formed on the top face 20 side, the painted sheet laminated layer being formed by lamination molding of a painted sheet.

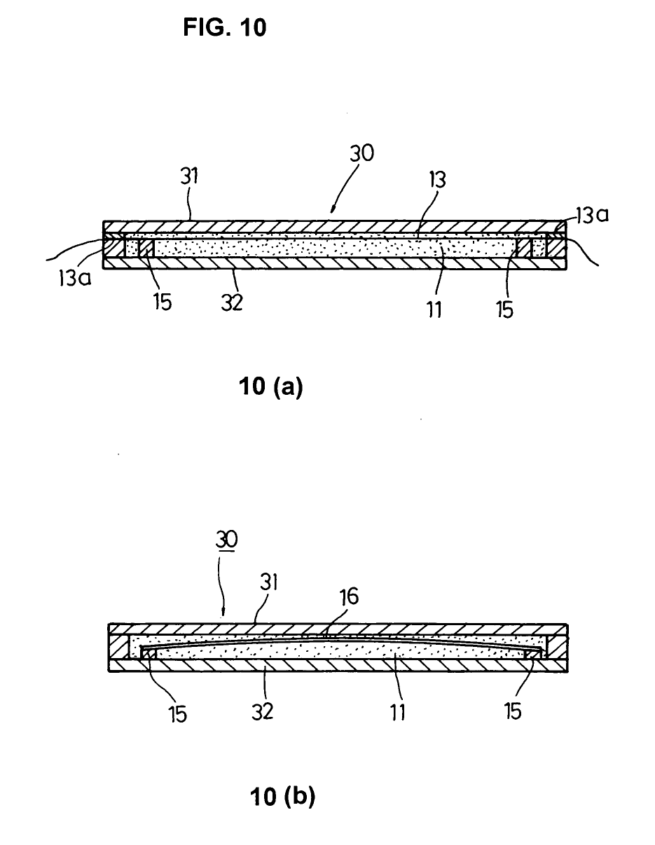

There will be explained examples of the ways of forming the cab roof members described in the foregoing embodiments. Molding of the above cab roof members is carried out with a resinous die and an RIM molding machine. Where a net or cloth made of high-strength organic fiber is incorporated as the reinforcing material 13, the rim 13a of the net or cloth is held, as shown in FIG. 10(a), between an upper die 31 and lower die 32 which constitute a molding die (resinous die) 30 and a resinous material is injected for molding while the net or cloth being stretched. Where an iron plate is incorporated as the reinforcing material 16, the iron plate (the reinforcing material 16) is placed with its outer circumference put in the molding die 30 as shown in FIG. 10(b). Then, a resinous material is injected while the iron plate being supported by fastening pieces (e.g., the embedded nuts 15) at its periphery so as to float within the die. Where an iron plate is used as the reinforcing material 16, the rim of the iron plate may be pinched by the periphery of the molding die 30 in some cases. There will be hereinafter explained examples associated with the way of interposing the reinforcing material by use of the resinous die and the internal structures of the molded panels described earlier.

### EXAMPLE 1

A resinous die composed of upper and lower dies is used. An urethane-based coating material for forming a coating film is sprayed beforehand onto the face of the upper die, the face corresponding to the top face of the cab roof member. Then, a sheet having a leather-like skin is laid over the face of the lower die so as to fit the shape of the lower die, the face corresponding to the ceiling face of the cab roof member and being opposed to the face of the upper die. The above sheet is made of an olefin-based material (e.g., “PEF” produced by Toray Industries, Inc.). An iron plate having a thickness of 4.2 mm and width/length that are long enough to mount the iron plate on the operator's cab structural frame is inserted between the mating faces of the upper and lower dies which are in turn clamped. Thereafter, a polyurethane resin material having two functional groups and a polyurethane resin material having three functional groups are injected into the dies by the RIM molding machine. After reactive curing of the polyurethane resin materials, the upper and lower dies are unclamped and the molded product is released from the dies.

The cab roof member thus produced is a foamed roof member in which its top face is coated with an urethane-based coating material by in-mold coating, an iron plate (a thickness of 4.2 mm) is included as an reinforcing plate, and its ceiling face is formed from an olefin-based foam having a leather-like skin. The portion of the iron plate sticking out of the edges of the foam (polyurethane) is designed to have holes (bolt holes or screw holes) at its edges so that the sticking-out portion can be used as a joint to be joined to the operator's cab structural frame, thereby achieving easy attachment structure.

### EXAMPLE 2

A resinous die composed of upper and lower dies is used. An urethane-based material for forming a coating film is sprayed beforehand onto the face (corresponding to the top face) of the upper die, whereas a PET nonwoven cloth is affixed to the opposed face (corresponding to the ceiling face) of the lower die. A PET wool serving as a sound absorbing material is laid over the nonwoven cloth. Subsequently, an iron plate having a thickness of 4.2 mm and width/length that are long enough to mount the iron plate on the operator's cab structure frame is inserted between the mating faces of the upper and lower dies which are in turn clamped. Thereafter, a structural polyurethane foam is injected into the dies to perform RIM molding. After reactive curing of the polyurethane foam, the dies are unclamped and the molded product is released from the dies.

The cab roof member thus obtained is structured such that its top face is coated whereas its ceiling face is covered with a nonwoven cloth, a sound absorbing layer is disposed just under the ceiling face, and its inner portion is reinforced by an iron plate. The portion of the iron plate sticking out of the molded portion is provided with mounting holes used for attaching the cab roof member to the operator's cab structure frame, similarly to Example 1.

### EXAMPLE 3

A resinous die composed of upper and lower dies is used. A PET nonwoven cloth is affixed to the face (corresponding to the ceiling face) of the lower die, and an iron plate is placed on the mating face of the lower die. Then, clamping is carried out with the help of the iron plate to perform foaming/RIM molding by use of a soft polyurethane resin, so that the soft polyurethane resin reacts to cure between the iron plate and the nonwoven cloth, thereby integrally bonding the iron plate and the nonwoven cloth to each other. Thereafter, an urethane-based coating material is sprayed onto the face (corresponding to the top face) of the upper die for coating. This upper die is laid over the outer face of the iron plate of the previously molded part to carry out clamping. Then, a structural polyurethane resin is injected into the dies to perform foaming/RIM molding.

The cab roof member thus obtained is structured such that a hard polyurethane foam having a coating layer on the top face side is formed, an impact-resistant layer constituted by an iron plate is formed in the mid position, and a sound absorbing layer made of a soft polyurethane resin and having a PET nonwoven cloth on its surface is formed on the ceiling face side. The portion of the iron plate sticking out of the molded portion is utilized for joining the cab roof member to the operator's cab structure frame.

### EXAMPLE 4

A resinous die composed of upper and lower dies is used. An urethane-based coating material for forming a coating film is sprayed beforehand onto the face (corresponding to the top face) of the upper die. Then, a sheet made of an olefin-based material and having a leather-like surface (e.g., “PEF” produced by Toray Industries, Ltd.) is laid over the opposed face (corresponding to the ceiling face) of the lower die so as to fit the shape of the lower die. A net made from a polyamide single fiber (untwisted fiber) is inserted between the mating faces of the upper and lower dies which are in turn clamped. Thereafter, a polyurethane resin material having two functional groups and a polyurethane resin having three functional groups are injected into the dies by an RIM injection machine. After reactive curing of the injected polyurethane resin materials, the dies are unclamped to remove the molded product therefrom.

The cab roof member thus obtained gives a good tactile impression and is structured such that its top face is coated with an urethane-based coating material by in-mold coating, a net made from a polyamide fiber is provided in the mid position as a reinforcing material, and its ceiling face is formed from an olefin-based foam having a leather-like skin.

### EXAMPLE 5

A resinous die composed of upper and lower dies is used. An urethane-based material for forming a coating film is sprayed beforehand onto the face (corresponding to the top face) of the upper die, whereas a PET nonwoven cloth is affixed to the opposed face (corresponding to the ceiling face) of the lower die. Then, a PET wool serving as a sound absorbing material is laid over the nonwoven cloth. Subsequently, a net made from a polyamide single fiber (untwisted fiber) is inserted between the mating faces of the upper and lower dies which are in turn clamped. Thereafter, a structural polyurethane foam is injected into the clamped dies thereby performing RIM molding. After reactive curing of the structural polyurethane foam, the dies are opened to remove the molded product therefrom.

The cab roof member thus obtained is structured such that its top face is coated with an urethane-based material by in-mold coating whereas its ceiling face is covered with a nonwoven cloth, a sound absorbing layer is formed at the mid position, and the inner part is reinforced by a polyamide fiber.

### EXAMPLE 6

A resinous die composed of upper and lower dies is used. A PET nonwoven cloth is affixed to the face (corresponding to the ceiling face) of the lower die. A cloth made from a polyamide single fiber (untwisted fiber) is placed on the mating face of the lower die, and then clamping is done with the help of an iron plate. Subsequently, foaming/RIM molding is done using a soft polyurethane resin, so that the soft polyurethane foam reacts to cure between the cloth made from a polyamide single fiber and the nonwoven cloth, thereby bonding these cloths to each other. The iron plate, which has been used for assisting the clamping, is removed. Thereafter, an urethane-based coating material is sprayed onto the surface (corresponding to the top face) of the upper die for coating, and this upper die is clamped to the polyamide cloth side of the previously molded part. Then, a structural polyurethane resin is injected between the upper and lower dies to perform foaming/RIM molding.

The cab roof member thus obtained is structured such that a hard polyurethane foam layer having an in-mold coating layer is formed on the top face side, a cloth of a polyamide single fiber having impact resistance is formed at the intermediate part, and a sound absorbing layer constituted by a soft polyurethane foam layer and a PET nonwoven cloth constituting the ceiling surface are formed on the ceiling face side.

The cab roof members obtained in the above examples have the following effects. Thanks to the in-mold coating layer formed on the top face side, the top face of the molded product is already in a coated condition so that coating carried out after molding becomes unnecessary. This coating film is firmly bonded so that peeling-off of the film does not occur during use. In addition, the formation of the above coating layer allows the polyurethane foam serving as the main body of the cab roof member to have satisfactory weather resistance. The cab roof member includes an impact-resistant material which functions to prevent damage caused by falling objects. The cab roof members having an iron plate disposed therein have good sound insulation ability so that noise penetrating from outside can be reduced by about 3 db in maximum. The provision of the sound absorbing layer located on the ceiling face side reduces noise by 2 db in maximum compared to the conventional roof made from sheet metal. By covering the surface of the sound absorbing layer with a nonwoven cloth or leather-like sheet, an improved tactile impression and improved appearance quality can be achieved. Additionally, since the cab roof member of the invention is formed from a foam, improved heat insulation properties can be achieved and the work environment within the operator's cab can be improved.

Apart from the above-described effects, the invention has the effect of offering significant manufacturing cost reduction. Concretely, while injection press molding is conventionally essential for, for example, lamination molding of a soft sound adsorbing material to a thermoplastic resin (such as polypropylene), the invention employs the RIM molding of polyurethane in which the cost of the die is one figure smaller than that of the injection press molding since the RIM molding using polyurethane is lower pressure molding.

Where an iron plate is incorporated in the cab roof member with the aim of enhancing sound insulation and reinforcement, the iron plate may be entirely enclosed by the foam layer or alternatively disposed with its rim protruding from the foam layer as described earlier. In the latter case, the sticking-out portion is provided with mounting holes for facilitating the attachment of the cab roof member to the upper end of the operator's cab structural frame and the outer surface of the sticking-out portion is painted or covered with a cover material to ensure long service life. Further, it is possible depending on the molding process that only the portion to be joined to the upper end of the operator's cab structural frame may be designed to stick out and the sticking-out portion may be provided with mounting holes. Although an iron plate is included in the cab roof member for sound insulation and reinforcement in the foregoing description, it may be replaced with other metal plates as far as they have the same effect.

Since the cab roof member is molded from a foamed resin, it is possible to embed accessories (not shown) of the operator's cab (e.g., an installation part of a lightening fixture and wiring) in the base material layer (the foam layer) during the molding process. With this arrangement, the number of assembling processes can be reduced and the secondary effect of improving the appearance and quality of the finished product can be obtained. As a matter of course, such an arrangement falls within the scope of the invention.

1. A cab roof member for a work machine, which is a roof member of an operator's cab of a work machine and which comprises a foam formed by foaming a plastic material in which a net-like or fabric-like reinforcing material consisting of a high-strength organic fiber is included.

2. The cab roof member for a work machine according to claim 1, wherein the high-strength organic fiber is selected from the group consisting of polyamide single fibers, polyester-based high-strength fibers, carbon fibers and any combination thereof.

3. A cab roof member for a work machine, which is a roof member of an operator's cab of a work machine and which comprises a foam formed by foaming a plastic material in which a reinforcing material consisting of an iron plate is included.

4. The cab roof member for a work machine according to claim 3, wherein the iron plate has enough strength to withstand shocks caused by falling objects and is larger in size than a structural member for keeping the strength of the operator's cab.

5. The cab roof member for a work machine according to claim 1, wherein the reinforcing material is integrated with said foam.

6. A cab roof member for a work machine, which is a roof member of an operator's cab of a work machine and wherein a sound absorption functional layer is formed on a face of a foam formed by foaming a plastic material, said face of the foam being located on the side corresponding to a ceiling face of the operator's cab.

7. The cab roof member for a work machine according to claim 6, wherein the sound absorption functional layer is constituted by a polyurethane foam, a foam of a polyolefin-based material, a PET fiber, a glass fiber, or any combination thereof.

8. The cab roof member for a work machine according to claim 6, wherein the surface of the sound absorption functional layer is covered with a sheet material having high porosity selected from the group consisting of cotton fabrics, nylon fabrics and nonwoven fabrics.

9. The cab roof member for a work machine according to claim 6, wherein the skin of the sound absorption functional layer is coated with a thin, thermoplastic sheet material.

10. The cab roof member for a work machine according to claim 6, wherein the sound absorption functional material is integrated with said foam.

11. The cab roof member for a work machine according to claims 1, wherein the plastic material is a polyurethane resin.

12. The cab roof member for a work machine according to claim 1, wherein a top face is curved so as to bulge upwardly and the reinforcing material is internally disposed so as to extend along the curved face.

13. The cab roof member for a work machine according to claim 1, wherein a mold coating layer or painted sheet laminated layer is formed on a top face side.

14. The cab roof member for a work machine according to claim 1, which is molded with fastening pieces embedded in a joint area to be joined to a structural frame of the operator's cab and which can be integrated with the structural frame by bringing mating fastening members into engagement with the fastening pieces through the structural frame when assembling the operator's cab.

15. The cab roof member for a work machine according to claim 3, wherein the reinforcing material is integrated with said foam.

16. The cab roof member for a work machine according to claim 3, wherein the plastic material is a polyurethane resin.

17. The cab roof member for a work machine according to claim 6, wherein the plastic material is a polyurethane resin.

18. The cab roof member for a work machine according to claim 3, wherein a top face is curved so as to bulge upwardly and the reinforcing material is internally disposed so as to extend along the curved face.

19. The cab roof member for a work machine according to claim 6, wherein a top face is curved so as to bulge upwardly and the reinforcing material is internally disposed so as to extend along the curved face.

20. The cab roof member for a work machine according to claim 3, wherein a mold coating layer or painted sheet laminated layer is formed on a top face side.

21. The cab roof member for a work machine according to claim 6, wherein a mold coating layer or painted sheet laminated layer is formed on a top face side.

22. The cab roof member for a work machine according to claim 3, which is molded with fastening pieces embedded in a joint area to be joined to a structural frame of the operator's cab and which can be integrated with the structural frame by bringing mating fastening members into engagement with the fastening pieces through the structural frame when assembling the operator's cab.

23. The cab roof member for a work machine according to claim 6, which is molded with fastening pieces embedded in a joint area to be joined to a structural frame of the operator's cab and which can be integrated with the structural frame by bringing mating fastening members into engagement with the fastening pieces through the structural frame when assembling the operator's cab.
